(19) United States
(12) Patent Application Publication
(10) Pub. No.: US 2025/0389321 A1
(43) Pub. Date: Dec. 25, 2025

(54) ROTATIONAL BODY DRIVE DEVICE AND POSITION SENSOR UNIT USED IN SAME

(71) Applicant: Panasonic Intellectual Property Management Co., Ltd., Osaka (JP)

(72) Inventors: Naofumi TAKAYA, Osaka (JP); Yoshio Naka, Osaka (JP); Masayuki Hino, Hyogo (JP); So Watanabe, Kanagawa (JP); Hiroki Yamanaka, Osaka (JP)

(21) Appl. No.: 19/316,238

(22) Filed: Sep. 2, 2025

Related U.S. Application Data
(63) Continuation of application No. PCT/JP2024/005731, filed on Feb. 19, 2024.

(30) Foreign Application Priority Data
Mar. 3, 2023 (JP) 2023-032848

(51) Int. Cl. F16H 37/16; F16H 1/06; G02B 7/02; G03B 21/14

(52) U.S. Cl. CPC F16H 37/16; F16H 1/06; G02B 7/02; G03B 21/14

(57) ABSTRACT

A rotating body drive device includes: a rotating body including outer teeth; a drive gear that meshes with the outer teeth of the rotating body and rotates about a rotation center line parallel to a rotation center line of the rotating body; and a position detection unit that detects a rotational angular position of the rotating body. The position detection unit includes: a base member; a rotationally moving member supported by the base member to be rotationally movable about a first rotation center line parallel to the rotation center line; a first gear that is supported by the rotationally moving member to be rotatable about a second rotation center line parallel to the first rotation center line and meshes with the outer teeth of the rotating body; and a sensor that is provided on the rotationally moving member and detects a rotational angular position of the first gear.

### CROSS-REFERENCE OF RELATED APPLICATIONS

This application is a Continuation of International Patent Application No. PCT/JP2024/005731, filed on Feb. 19, 2024, which in turn claims the benefit of Japanese Patent Application No. 2023-032848, filed on Mar. 3, 2023, the entire disclosures of which Applications are incorporated by reference herein.

### TECHNICAL FIELD

The present disclosure relates to a rotating body drive device that rotates a rotating body and to a position sensor unit used for the rotating body drive device.

### BACKGROUND ART

For example, JP 2017-67247 A discloses a device that rotates a worm wheel (rotating body). A worm (drive gear) meshing with outer teeth of the worm wheel is rotated by a motor. In addition, a worm gear is supported by a support base attached to a tip (free end) of a leaf spring. The leaf spring biases the worm toward the worm wheel.

This eliminates backlash between the worm wheel and the worm. By eliminating the backlash, the rotational angular position of the worm wheel can be adjusted with high accuracy by the motor.

### SUMMARY

An object of the present disclosure is to adjust, in a rotating body drive device including a rotating body including outer teeth and a drive gear that rotates the rotating body, a rotational angular position of the rotating body with high accuracy regardless of the presence or absence of backlash between the outer teeth of the rotating body and the drive gear.

In order to solve the above problem, according to an aspect of the present disclosure, a rotating body drive device is provided that includes:
a rotating body including outer teeth;
a drive gear that meshes with the outer teeth of the rotating body and rotates about a rotation center line parallel to a rotation center line of the rotating body; and
a position detection unit that detects a rotational angular position of the rotating body, the position detection unit including:
   a base member;
   a rotationally moving member supported by the base member to be rotationally movable about a first rotation center line parallel to the rotation center line of the rotating body;
   a first gear that is supported by the rotationally moving member to be rotatable about a second rotation center line parallel to the first rotation center line and meshes with the outer teeth of the rotating body; and
   a sensor that is provided on the rotationally moving member and detects a rotational angular position of the first gear.

According to another aspect of the present disclosure, a rotating body drive device is provided that includes:
a rotating body including outer teeth;
a drive gear that rotates in mesh with the outer teeth of the rotating body; and
a position detection unit that detects a rotational angular position of the rotating body, the position detection unit including:
   a base member;
   a rotationally moving member supported by the base member to be rotationally movable with respect to a rotation center line of the rotating body; and
   a first gear that is rotatably supported by the rotationally moving member and meshes with the outer teeth of the rotating body;
   a sensor that is provided on the rotationally moving member and detects a rotational angular position of the first gear;
   a second gear coupled to the first gear in an axial direction of the first gear;
   a third gear that is rotatably supported by the rotationally moving member and meshes with the second gear and whose rotation angle is detected by the sensor;
   a shaft that connects the first gear and the second gear in the axial direction; and
   a cylindrical bearing that rotatably supports the shaft.

According to an aspect of the present disclosure, a position sensor unit is provided that includes:
a base member;
a rotationally moving member supported by the base member to be rotationally movable about a first rotation center line parallel to the rotation center line of the rotating body;
a first gear that is supported by the rotationally moving member to be rotatable about a second rotation center line parallel to the first rotation center line and meshes with the outer teeth of the rotating body; and
a sensor that is provided on the rotationally moving member and detects a rotational angular position of the first gear.

With the present disclosure, in a rotating body drive device including a rotating body including outer teeth and a drive gear that rotates the rotating body, it is possible to adjust a rotational angular position of the rotating body with high accuracy regardless of the presence or absence of the backlash between the outer teeth of the rotating body and the drive gear.

### BRIEF DESCRIPTION OF DRAWINGS

FIG. 1 is a schematic perspective view of a projector on which a lens drive device according to an embodiment of the present disclosure is mounted;

FIG. 2 is a perspective view of the lens drive device;

FIG. 3 is an exploded perspective view of the lens drive device;

FIG. 4 is an exploded perspective view of a lens barrel;

FIG. 5 is an exploded perspective view of a position detection unit;

FIG. 6 is a cross-sectional view illustrating meshing between a second gear and a third gear;

FIG. 7 is a diagram illustrating a casing of a position detection unit biased by a biasing member;

FIG. 8 is a front view of the casing in the position detection unit; and

FIG. 9 is a diagram illustrating a state in which the second gear is shifted toward the third gear.

### DETAILED DESCRIPTION

Hereinafter, an embodiment will be described in detail with reference to the drawings as appropriate. However, unnecessarily detailed descriptions may be omitted. For example, a detailed description of an already well-known matter and repeated description of substantially the same configuration may be omitted. This is to prevent the following description from being unnecessarily redundant and to facilitate those skilled in the art to understand the present disclosure.

Note that the inventors provide the accompanying drawings and the following description for those skilled in the art to fully understand the present disclosure, and the drawings and the description are not intended to limit the subject matters of the claims.

Hereinafter, a projector according to an embodiment of the present disclosure will be described with reference to the drawings.

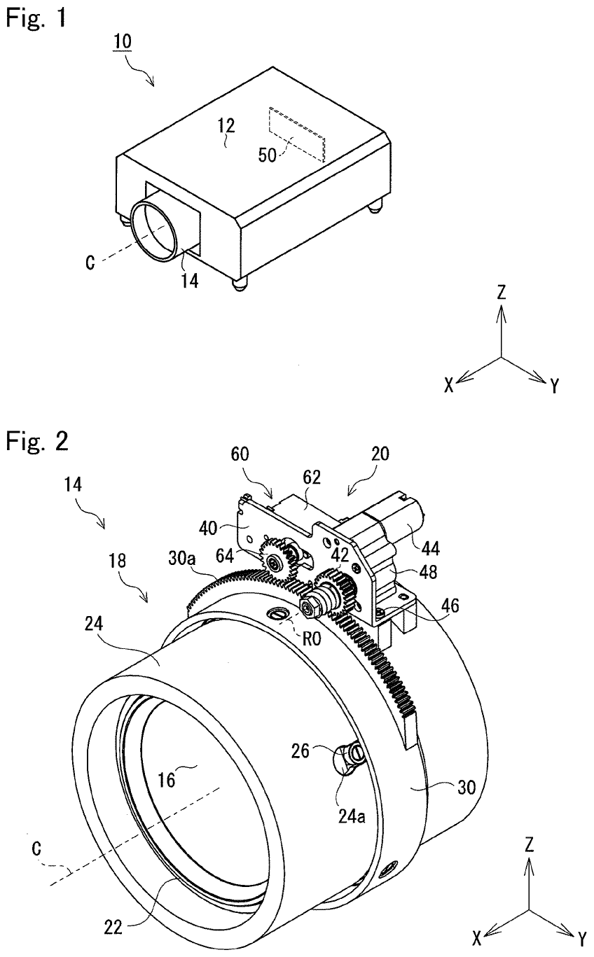

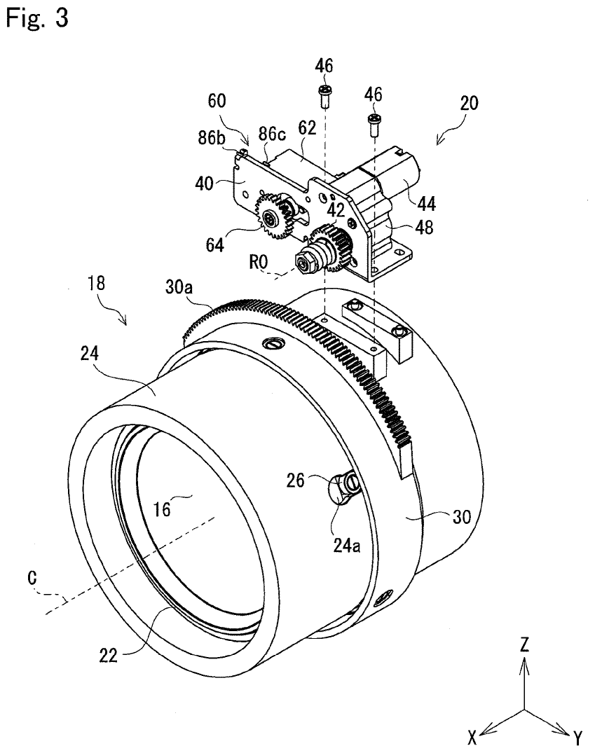

FIG. 1 is a schematic perspective view of a projector on which a lens drive device according to an embodiment of the present disclosure is mounted. FIG. 2 is a perspective view of the lens drive device. FIG. 3 is an exploded perspective view of the lens drive device.

Note that an X-Y-Z orthogonal coordinate system illustrated in the drawings is for facilitating understanding of the embodiment of the present disclosure, and does not limit the embodiment of the present disclosure. The X-axis direction is a front-rear direction of the projector, the Y-axis direction is a left-right direction, and the Z-axis direction is a height direction.

As illustrated in FIG. 1, a projector 10 includes a housing 12 and a lens drive device 14 (rotating body drive device) mounted on the housing 12. As illustrated in FIGS. 2 and 3, the lens drive device 14 includes a lens barrel 18 including a lens 16, and a lens drive module 20 that shifts the lens 16 of the lens barrel 18 in an extending direction of the optical axis C of the lens 16 (X-axis direction). First, the lens barrel 18 will be described.

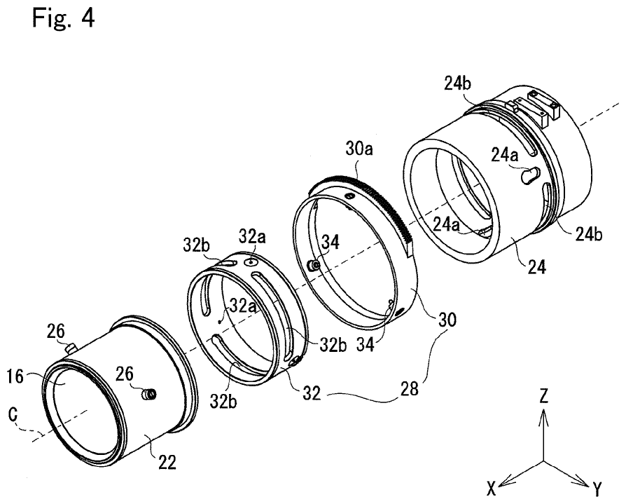

FIG. 4 is an exploded perspective view of the lens barrel.

As illustrated in FIG. 4, the lens barrel 18 includes: a cylindrical lens support member 22 that supports the lens 16; and a cylindrical lens barrel body 24 that supports the lens support member 22 such that the lens support member 22 can shift in the extending direction of the optical axis C (X-axis direction). Note that the lens barrel 18 is attached to the housing 12 of the projector 10 via the lens barrel body 24.

Specifically, the lens support member 22 is accommodated in the lens barrel body 24 so as to be shiftable in the extending direction of the optical axis C (X-axis direction). A plurality of guide pins 26 are provided on an outer peripheral surface of the lens support member 22. A plurality of guide holes 24a that each guide one of the plurality of guide pins 26 are provided in the lens barrel body 24. The guide holes 24a each extend in the extending direction of the optical axis C.

The lens barrel 18 includes a cam unit 28 that shifts the lens support member 22 in the extending direction of the optical axis C (X-axis direction). The cam unit 28 includes: a cylindrical outer cam 30 externally inserted into the lens barrel body 24; and an inner cam 32 externally inserted into the lens support member 22 while being inserted into the lens barrel body 24.

The outer cam 30 of the cam unit 28 is supported by the lens barrel body 24 so as to be rotationally movable in a circumferential direction of an outer peripheral surface of the lens barrel body 24. Specifically, a plurality of guide pins 34 are provided on an inner peripheral surface of the outer cam 30. A plurality of guide holes 24b that each guide one of the plurality of guide pins 34 are provided in the lens barrel body 24. The guide holes 24b each extend in the circumferential direction of the outer peripheral surface of the lens barrel body 24.

The guide pins 34 are fixed to the outer cam 30. The guide pins 34 also engage with a plurality of engagement holes 32a provided in the inner cam 32. Thus, the outer cam 30 and the inner cam 32 are integrated.

In the inner cam 32 of the cam unit 28, there are formed a plurality of cam grooves 32b that each move one of the plurality of guide pins 26 provided on the lens support member 22. The cam grooves 32b extend in a circumferential direction of an outer peripheral surface of the inner cam 32 and, at the same time, extend in the extending direction of the optical axis C (X-axis direction). As a result, when the inner cam 32 rotationally moves in the circumferential direction along the outer peripheral surface of the lens support member 22, the cam grooves 32b move the guide pins 26 in the extending direction of the optical axis C.

With such a lens barrel 18, when the outer cam 30 of the cam unit 28 rotationally moves about the optical axis C, the inner cam 32 connected to the outer cam 30 rotationally moves in the same direction. The rotational movement of the inner cam 32 causes the cam grooves 32b of the inner cam 32 to shift, via the guide pins 26, the lens support member 22, that is, the lens 16 in the extending direction of the optical axis C (X-axis direction). When the lens 16 is shifted in the extending direction of the optical axis C, focusing of an image projected through the lens 16 is adjusted.

In the case of the present embodiment, as illustrated in FIGS. 2 and 3, the outer cam 30 (rotating body) of the cam unit 28 of the lens barrel 18 is rotated by the lens drive module 20.

As illustrated in FIGS. 2 and 3, the lens drive module 20 includes: a base member 40, a drive gear 42 that rotates the outer cam 30 of the cam unit 28 of the lens barrel 18; and a motor 44 that rotates drive gear 42. In the case of the present embodiment, as illustrated in FIG. 3, the base member 40 is fixed to the lens barrel body 24 via fixing screws 46, thereby the lens drive module 20 is provided on the lens barrel 18. In the case of the present embodiment, a speed reduction mechanism 48 is provided between the drive gear 42 and the motor 44.

The drive gear 42 is a so-called spur gear, and is rotated about a rotation center line R0 extending in the extending direction of the optical axis C (X-axis direction) by the motor 44. As illustrated in FIG. 2, the outer cam 30 of the cam unit 28 is formed with outer teeth 30a extending in a circumferential direction of the outer cam 30 so that the outer cam 30 is rotated by the drive gear 42. The outer teeth 30a are gear teeth having a so-called spur gear shape. When the drive gear 42 meshing with the outer teeth 30a is rotated by the motor 44, the outer cam 30 rotates about the optical axis C. As illustrated in FIG. 1, the motor 44 is controlled by a controller 50 provided in the housing 12 of the projector 10. The controller 50 is, for example, a substrate on which a circuit, a processor, and the like are provided.

In the case of the present embodiment, in order for the motor 44 to adjust the rotational angular position of the outer cam 30, there is provided a position detection unit 60 to adjust a position of the lens 16 in the extending direction of the optical axis C (X-axis direction). In the present specification, the rotational angular position refers to a rotational angle from a reference posture.

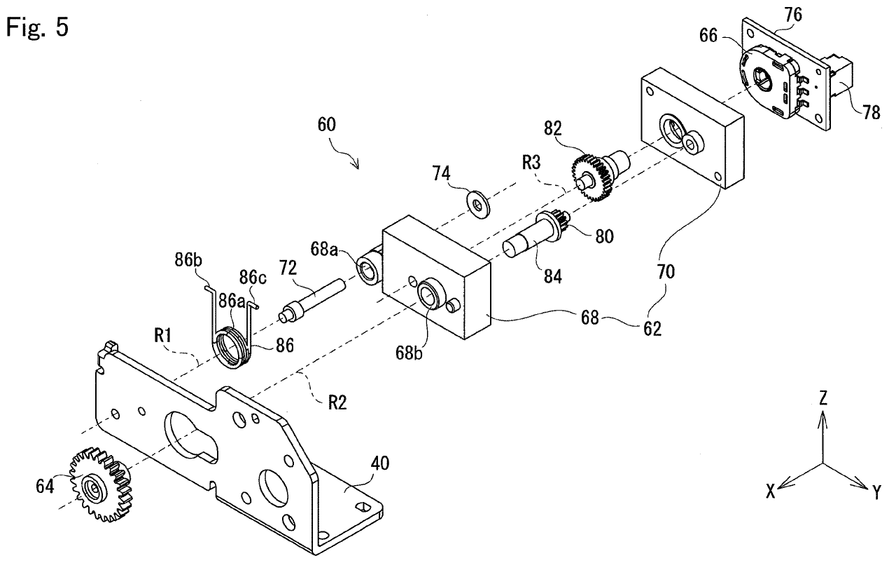

FIG. 5 is an exploded perspective view of the position detection unit.

In the case of the present embodiment, the position detection unit 60 is a part of the lens drive module 20. Specifically, as illustrated in FIG. 5, the position detection unit 60 includes: the base member 40; a casing (rotationally moving member) 62 supported by the base member 40; a first gear 64 supported by the casing 62; and a sensor 66 for detecting a rotational angular position of the first gear 64.

In the case of the present embodiment, the casing 62 includes a front casing 68 and a rear casing 70. Although the reason will be described later, the casing 62 is supported by the base member 40 so as to be rotationally movable about a first rotation center line R1 parallel to a rotation center line of the outer cam 30, in other words, the optical axis C. Specifically, in the case of the present embodiment, there is formed a through hole 68a in the casing 62 (specifically, the front casing 68 of the casing 62) to penetrate in an extending direction of the first rotation center line R1 (X-axis direction), and a support rod 72 is inserted in the through hole 68a. One end of the support rod 72 is supported by the base member 40. A slit washer 74 for preventing the casing 62 from falling off is attached to the other end of the support rod 72.

The first gear 64 is supported by the casing 62 so as to be rotatable about a second rotation center line R2 parallel to the first rotation center line R1. As illustrated in FIG. 2, the first gear 64 meshes with the outer teeth 30a of the outer cam 30. As a result, when the outer cam 30 rotates about the optical axis C, the first gear 64 rotates about the second rotation center line R2.

The sensor 66 is a position sensor such as a so-called rotary encoder that detects a rotational angular position of the first gear 64. In the case of the present embodiment, the sensor 66 is mounted on a substrate 76, and the substrate 76 is attached to the casing 62. Note that the substrate 76 is provided with a connector 78 for electrically connecting the controller 50 and the sensor 66 in the housing 12 of the projector 10.

Note that, in the case of the present embodiment, the rotational angular position of the first gear 64 is indirectly detected. Specifically, a second gear 80 and a third gear 82 are provided in the casing 62.

The second gear 80 is a so-called spur gear. The second gear 80 is provided on one end of a shaft 84 penetrating the front casing 68. The other end of the shaft 84 is connected to the first gear 64. That is, the first gear 64 and the second gear 80 are connected in the axial direction (X-axis direction) via the shaft 84. The shaft 84 is rotatably supported by a bearing 68b formed integrally with the front casing 68. In the case of the present embodiment, the second gear 80 and the shaft 84 are integrated.

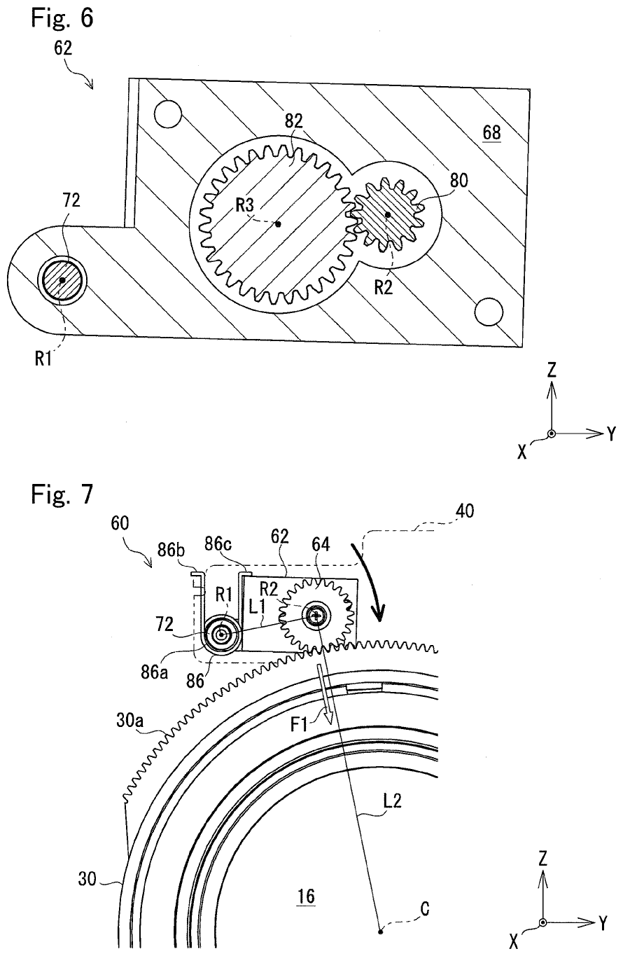

FIG. 6 is a cross-sectional view illustrating the meshing between the second gear and the third gear.

As illustrated in FIG. 6, the third gear 82 meshes with the second gear 80 in the casing 62. As illustrated in FIG. 5, the third gear 82 is a so-called spur gear, and is supported by the casing 62 so as to be rotatable about a third rotation center line R3 parallel to the second rotation center line R2. The third gear 82 is connected to the sensor 66. The sensor 66 detects a rotational angular position of the third gear 82.

That is, in the case of the present embodiment, the first gear 64 is connected to the sensor 66 via the second gear 80 and the third gear 82. As a result, the rotational angular position of the first gear 64 is indirectly detected. Specifically, the sensor 66 detects the rotational angular position of the third gear 82, and transmits a signal corresponding to a result of the detection to the controller 50. The controller 50 calculates the rotational angular position of the first gear 64 connected to the second gear 80, based on the signal from the sensor 66 and a gear ratio between the second gear 80 and the third gear 82. Then, the controller 50 calculates the rotational angular position of the outer cam 30, based on the calculated rotational angular position of the first gear 64 and a gear ratio between the outer teeth 30a of the outer cam 30 and the first gear 64. Since a relationship between the rotational angular position of the outer cam 30 and the position of the lens 16 in the extending direction of the optical axis C (X-axis direction) is in a certain relationship, the position of the lens 16 can be specified from the rotational angular position of the outer cam 30.

In order to detect the position of the lens 16 with high accuracy so that the rotational angular position of the outer cam 30 is detected with high accuracy, in the case of the present embodiment, backlash between the outer teeth 30a of the outer cam 30 and the first gear 64 is eliminated. Specifically, as illustrated in FIG. 5, the position detection unit 60 includes a biasing member 86 that biases the casing 62 so that the first gear 64 continues to be in contact with the outer cam 30.

FIG. 7 is a diagram illustrating the casing of the position detection unit biased by the biasing member.

As illustrated in FIGS. 5 and 7, in the case of the present embodiment, the biasing member 86 is a torsion spring. The biasing member 86 is provided such that the support rod 72 passes through a coil portion 86a of the biasing member 86. One end 86b of the biasing member 86 is hooked on the base member 40, and the other end 86c is hooked on the casing 62.

With such a biasing member 86, the casing 62 rotationally moves about the first rotation center line R1 toward the outer cam 30, and the first gear 64 continues to be in contact with the outer teeth 30a of the outer cam 30.

In the case of the present embodiment, as illustrated in FIG. 7, since the casing 62 is positioned above the outer cam 30, the first gear 64 comes into contact with the outer teeth 30a of the outer cam 30 due to a weight of the casing 62. In order to maintain this contact, the biasing member 86 continues to bias the casing 62 toward the outer cam 30.

Such a biasing member 86 makes it possible to eliminate the backlash between the outer teeth 30a of the outer cam 30 and the first gear 64. As a result, the rotational angular position of the outer cam 30 and a contact state between the outer teeth 30a and the first gear 64 have a one-to-one correspondence relationship. That is, the rotational angular position of the outer cam 30 and the rotational angular position of the first gear 64 have a one-to-one correspondence relationship. As a result, the rotational angular position of the outer cam 30 can be detected with high accuracy via the first gear 64.

The biasing member 86 biases the first gear 64 toward the outer teeth 30a of the outer cam 30 via the casing 62, so that a torque load acting on the motor 44 that rotates the outer cam 30 increases (as compared to a case where the first gear 64 is not biased). In this regard, the first gear 64 is preferably in contact with the outer teeth 30a such that no excessive torque load acts on the motor 44.

Therefore, as illustrated in FIG. 7, the first gear 64 is disposed with respect to the casing 62 in the following state. The casing 62 is disposed with respect to the outer cam 30 such that a straight line L1 connecting the first rotation center line R1 and the second rotation center line R2 is orthogonal to a straight line L2 connecting the optical axis C and the second rotation center line R2 as viewed in the extending direction of the rotation center line (that is, the optical axis C) (X-axis direction) of the outer cam 30. As a result, a biasing force F1 from the biasing member 86 via the first gear 64 acts on the outer cam 30 toward the optical axis C. Note that, in FIG. 7, a white arrow indicating the biasing force F1 is illustrated to be displaced so as not to overlap with the second straight line L2. As a result, the torque load acting on the motor 44 during a forward rotation of the outer cam 30 and the torque load acting during a reverse rotation are substantially the same and small.

In the case of the present embodiment, in addition to the meshing between the outer teeth 30a of the outer cam 30 and the first gear 64, the meshing between the second gear 80 and the third gear 82 is present. In order to detect the rotational angular position of the outer cam 30 with high accuracy, it is necessary to eliminate backlash between the second gear 80 and the third gear 82 as much as possible.

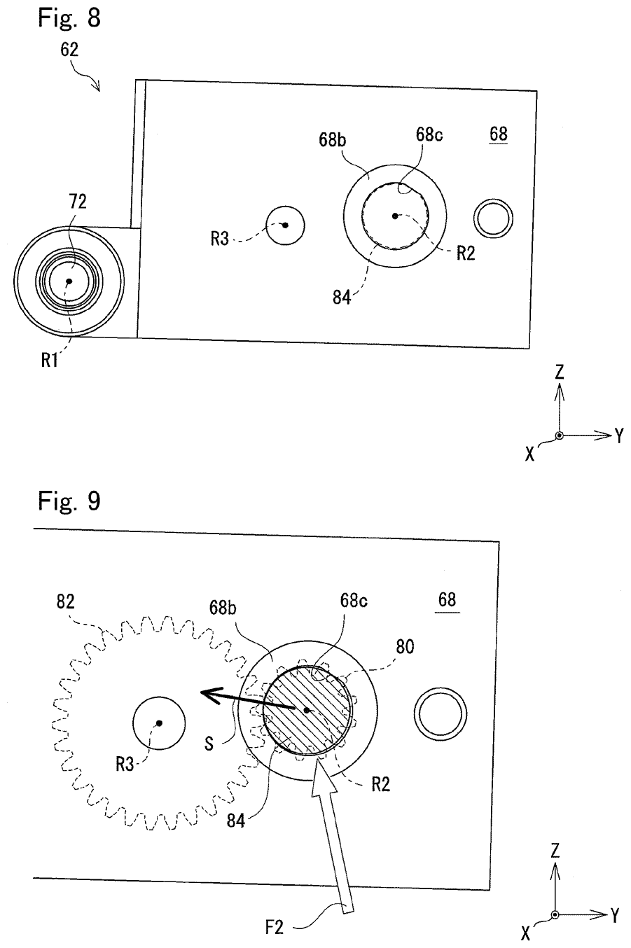

FIG. 8 is a front view of the casing in the position detection unit. FIG. 9 is a diagram illustrating a state in which the second gear is shifted toward the third gear.

As illustrated in FIGS. 8 and 9, in the case of the present embodiment, in order to eliminate the backlash between the second gear 80 and the third gear 82 as much as possible, a protruding portion 68c is provided on an inner surface of the cylindrical bearing 68b of the front casing 68 of the casing 62. In the case of the present embodiment, since a cross-sectional shape of the through-hole in the bearing 68b is formed in a “D” shape, the protruding portion 68c is provided on the inner surface of the bearing 68b. The backlash between the second gear 80 and the third gear 82 is eliminated as much as possible by the protruding portion 68c and a reaction force F2 that is from the outer teeth 30a of the outer cam 30 and is received by the first gear 64.

In specific description, as illustrated in FIG. 7, when the biasing force F1 of the biasing member 86 acts on the outer teeth 30a of the outer cam 30 via the first gear 64, the reaction force F2 directed from the outer teeth 30a toward the first gear 64 is generated. The reaction force F2 is a force having the same magnitude as the biasing force F1 and is directed opposite to the biasing force F1.

By the reaction force F2 acting on the first gear 64, the shaft 84 connected to the first gear 64 is shifted in the direction of the reaction force F2. However, when the shaft 84 comes into contact with the protruding portion 68c in the bearing 68b, the shaft 84 is shifted in a direction S different from the direction of the reaction force F2. Since the protruding portion 68c is provided at an appropriate position on the inner surface of the bearing 68b, the shaft 84 is shifted in a direction in which the shaft comes closer to the third rotation center line R3. As a result, the second gear 80 connected to the shaft 84 is shifted toward the third gear 82, thereby eliminating the backlash between the second gear 80 and the third gear 82 as much as possible. Such elimination of backlash is realized due to the fact that there is a minute gap between the inner surface of the bearing 68b and the shaft 84 in order for the bearing 68b to rotatably support the shaft 84.

Note that, if the third gear 82 is positioned in the direction of the biasing force F1 with respect to the second gear 80, it is impossible to eliminate backlash as described above. That is, the relative positions of the second gear 80 (that is, the first gear 64) and the third gear 82 with respect to the outer cam 30 are determined so as to make it possible to eliminate backlash as described above.

As described above, by eliminating the backlash between the outer teeth 30a of the outer cam 30 and the first gear 64 and the backlash between the second gear 80 and the third gear 82, the sensor 66 can detect the rotational angular position of the outer cam 30 with high accuracy.

Furthermore, when the controller 50 feedback-controls the motor 44 based on the rotational angular position of the outer cam 30 detected with high accuracy, the rotational angular position of the outer cam 30 can be adjusted with high accuracy. That is, in the case of the present embodiment, the position of the lens 16 in the extending direction of the optical axis C (X-axis direction) can be adjusted with high accuracy.

An embodiment of the present disclosure has been described above, but the present disclosure is not limited to the above-described embodiment.

For example, in the case of the above-described embodiment, as illustrated in FIG. 7, in the position detection unit 60, the biasing member 86 that biases the first gear 64 is a torsion spring. However, in the embodiment of the present disclosure, the biasing member 86 is not limited to a torsion spring. As long as the casing 62 supporting the first gear 64 can be rotated about the first rotation center line R1, the biasing member 86 may be different from a torsion spring.

Furthermore, in the case of the above-described embodiment, as illustrated in FIG. 7, the first gear 64 is biased toward the outer teeth 30a of the outer cam 30 by the biasing member 86, so that the contact between the first gear 64 and the outer teeth 30a of the outer cam 30 is maintained. Thus, the backlash between the first gear 64 and the outer teeth 30a is eliminated. However, the embodiment of the present disclosure is not limited thereto. For example, a magnet may be used to maintain the contact between the first gear 64 and the outer teeth 30a of the outer cam 30. Alternatively, the contact between the outer teeth 30a of the outer cam 30 and the first gear 64 may be maintained by the weight of the casing 62 and the sensor 66 and the like provided in the casing 62.

Furthermore, in the case of the above-described embodiment, the first gear 64 and the sensor 66 are connected to each other via the second gear 80 and the third gear 82. However, the embodiment of the present disclosure is not limited thereto. If possible, the first gear 64 may be directly connected to the sensor 66.

Furthermore, in the case of the above-described embodiment, there is no particular configuration for eliminating backlash between the outer teeth 30a of the outer cam 30 and the drive gear 42. The backlash between the outer teeth 30a and the drive gear 42 may be eliminated or may not be eliminated. That is, regardless of the presence or absence of the backlash between the outer teeth 30a and the drive gear 42, the rotational angular position of the outer cam 30 can be adjusted with high accuracy by the feedback-control performed on the motor 44 based on the rotational angular position of the outer cam 30 detected with high accuracy by the position detection unit 60.

In addition, in the case of the above-described embodiment, the drive gear 42 that rotates the outer cam 30 is rotated by the motor 44. However, the embodiment of the present disclosure is not limited thereto. Regarding the drive gear 42, for example, a user may rotate the drive gear 42 via a dial knob. In this case, the projector 10 is provided with a display that presents to the user the position of the lens corresponding to the rotational angular position of the outer cam 30 detected by the position detection unit 60. The user can adjust the lens to a desired position by rotating the dial knob, based on the position of the lens displayed on the display.

In addition, in the case of the above-described embodiment, the rotating body whose rotational angular position is detected is outer cam 30 in the lens barrel 18 that shifts lens 16 of the projector 10. However, the embodiment of the present disclosure is not limited thereto. The rotating body whose rotational angular position is detected only needs to be a rotating body having outer teeth.

Finally, since the embodiment of the present disclosure is for detecting the rotational angular position of the rotating body in a stopped state, it is not always necessary to eliminate the backlash between the outer teeth of the rotating body during rotation and the first gear. That is, the embodiment of the present disclosure eliminates the backlash between the outer teeth of the rotating body and the first gear so that the first gear comes into contact with the outer teeth of the rotating body in substantially the same manner even when the rotating body repeatedly stops at a predetermined rotational angular position.

That is, in a broad sense, a rotating body drive device according to an embodiment of the present disclosure includes: a rotating body including outer teeth; a drive gear that meshes with the outer teeth of the rotating body and rotates about a rotation center line parallel to a rotation center line of the rotating body; and a position detection unit that detects a rotational angular position of the rotating body, the position detection unit including: a base member; a rotationally moving member supported by the base member to be rotationally movable about a first rotation center line parallel to the rotation center line of the rotating body; a first gear that is supported by the rotationally moving member to be rotatable about a second rotation center line parallel to the first rotation center line and meshes with the outer teeth of the rotating body; and a sensor that is provided on the rotationally moving member and detects a rotational angular position of the first gear.

Also, in a broad sense, a position sensor unit according to an embodiment of the present disclosure includes: a base member; a rotationally moving member supported by the base member to be rotationally movable about a first rotation center line parallel to the rotation center line of the rotating body; a first gear that is supported by the rotationally moving member to be rotatable about a second rotation center line parallel to the first rotation center line and meshes with the outer teeth of the rotating body; and a sensor that is provided on the rotationally moving member and detects a rotational angular position of the first gear.

As described above, the above-described embodiment has been described as an example of the techniques in the present disclosure. For that purpose, the drawings and the detailed description are provided. Therefore, the components illustrated in the drawings and described in the detailed description can include, to exemplify the above-described techniques, not only components essential for solving the problems but also components not essential for solving the problems. For this reason, it should not be immediately recognized that those unnecessary components are necessary only because those unnecessary components are described in the drawings or the detailed description.

In addition, because the above-described embodiment is for illustrating the techniques in the present disclosure, various modifications, replacements, additions, removals, or the like can be made without departing from the scope of the claims or the equivalent thereto.

The present disclosure is applicable to a device that rotates a rotating body.

What is claimed is:

1. A rotating body drive device comprising:
a rotating body including outer teeth;
a drive gear that meshes with the outer teeth of the rotating body and rotates about a rotation center line parallel to a rotation center line of the rotating body; and
a position detection unit that detects a rotational angular position of the rotating body, the position detection unit including:
a base member;
a rotationally moving member supported by the base member to be rotationally movable about a first rotation center line parallel to the rotation center line of the rotating body;
a first gear that is supported by the rotationally moving member to be rotatable about a second rotation center line parallel to the first rotation center line and meshes with the outer teeth of the rotating body; and
a sensor that is provided on the rotationally moving member and detects a rotational angular position of the first gear.

2. The rotating body drive device according to claim 1, wherein the position detection unit further includes a biasing member that biases the rotationally moving member such that the first gear continues to be in contact with the rotating body.

3. The rotating body drive device according to claim 1, further comprising:
a motor that rotates the drive gear; and
a controller that feedback-controls the motor, based on a detection result of the sensor.

4. The rotating body drive device according to claim 3, wherein the drive gear and the motor are supported by the base member of the position detection unit.

5. The rotating body drive device according to claim 1, wherein a first straight line connecting the first rotation center line and the second rotation center line and a second straight line connecting the second rotation center line and the rotation center line of the rotating body are orthogonal to each other as viewed in an extending direction of the rotation center line of the rotating body.

6. The rotating body drive device according to claim 1, wherein the position detection unit includes:
a second gear coupled to the first gear in an axial direction of the first gear; and
a third gear that is supported by the rotationally moving member to be rotatable about a third rotation center line parallel to the first rotation center line and the second rotation center line and meshes with the second gear and whose rotation angle is detected by the sensor.

7. The rotating body drive device according to claim 6, wherein the position detection unit includes:
a shaft that connects the first gear and the second gear in the axial direction; and
a cylindrical bearing that rotatably supports the shaft, and
an inner surface of the cylindrical bearing is provided with a protrusion that comes into contact with the shaft and shifts the shaft toward the third gear.

8. The rotating body drive device according to claim 1, wherein the rotating body is a cylindrical cam that is provided on a lens barrel and moves a lens in the lens barrel in an optical axis direction.

9. The rotating body drive device according to claim 1, wherein the rotationally moving member is a casing.

10. A lens drive device comprising the rotating body drive device according to claim 1.

11. A projector comprising the lens drive device according to claim 10.

12. A rotating body drive device comprising:
a rotating body including outer teeth;
a drive gear that rotates in mesh with the outer teeth of the rotating body; and
a position detection unit that detects a rotational angular position of the rotating body, the position detection unit including:
a base member;
a rotationally moving member supported by the base member to be rotationally movable with respect to a rotation center line of the rotating body; and
a first gear that is rotatably supported by the rotationally moving member and meshes with the outer teeth of the rotating body;
a sensor that is provided on the rotationally moving member and detects a rotational angular position of the first gear;
a second gear coupled to the first gear in an axial direction of the first gear;
a third gear that is rotatably supported by the rotationally moving member and meshes with the second gear and whose rotation angle is detected by the sensor;
a shaft that connects the first gear and the second gear in the axial direction; and
a cylindrical bearing that rotatably supports the shaft.

13. The rotating body drive device according to claim 12, wherein an inner surface of the cylindrical bearing is provided with a protrusion that comes into contact with the shaft and shifts the shaft toward the third gear.

14. The rotating body drive device according to claim 12, wherein the position detection unit further includes a biasing member that biases the rotationally moving member such that the first gear continues to be in contact with the rotating body.

15. The rotating body drive device according to claim 12, further comprising:
a motor that rotates the drive gear; and
a controller that feedback-controls the motor, based on a detection result of the sensor.

16. The rotating body drive device according to claim 15, wherein the drive gear and the motor are supported by the base member of the position detection unit.

17. The rotating body drive device according to claim 12, wherein the rotating body is a cylindrical cam that is provided on a lens barrel and moves a lens in the lens barrel in an optical axis direction.

18. A lens drive device comprising the rotating body drive device according to claim 12.

19. A projector comprising the lens drive device according to claim 18.

20. A position sensor unit that detects a rotational angular position of a rotating body including outer teeth, the position sensor unit comprising:
a base member;
a rotationally moving member supported by the base member to be rotationally movable about a first rotation center line parallel to the rotation center line of the rotating body;
a first gear that is supported by the rotationally moving member to be rotatable about a second rotation center line parallel to the first rotation center line and meshes with the outer teeth of the rotating body; and
a sensor that is provided on the rotationally moving member and detects a rotational angular position of the first gear.
